(19) United States
(12) Patent Application Publication
(10) Pub. No.: US 2005/0121566 A1
(43) Pub. Date: Jun. 9, 2005

(54) X-style stand having disengageable crosspieces, and packaging combination including the same

(76) Inventors: James R. Hennessey, West Hartford, CT (US); Richard A. Angelillo, Newington, CT (US)

Correspondence Address: Ira S. Dorman;Suite 200, 330 Roberts Street, East Hartford, CT, 06108, US

(21) Appl. No.: 10/967,616

(22) Filed: Oct. 18, 2004

Related U.S. Application Data
(60) Provisional application No. 60/512,610, filed on Oct. 20, 2003.

(51) Int. Cl. A47G 23/02; F16M 11/24

(52) U.S. Cl. 248/150

(57) ABSTRACT

The support members of an X-style stand are separate from the brace assembly, and are assembled therewith by telescopic interengagement of at least one sleeve piece on the support member with the end portion of a leg of the brace, the sleeve piece being affixed to the support member with weldments that extend parallel to the longitudinal axis of the member. The sleeve pieces are fastened to the brace legs by elongate fasteners that extend through aligned apertures, which are also oriented parallel to the axis of the crosspiece. The disassembled stand is contained in a package that is of substantially reduced volume, as compared to the space required to contain an equivalent stand of conventionally welded construction.

### CROSS-REFERENCE TO RELATED APPLICATION

This application claims the benefit of U.S. Provisional Application No. 60/512,610, filed Oct. 20, 2003 in the names of the inventors designated herein, the entire specification of which Provisional Application is incorporated hereinto by reference thereto.

### BACKGROUND OF THE INVENTION

So-called “X-style” stands are widely used in the music industry, primarily for the support of keyboard instruments but also for supporting electronic sound-reproduction equipment and the like. Such stands must be strong and very stable, particularly if they are to enable adequate support of a keyboard instrument, which is constantly subjected to significant levels of asymmetric impact as the player strikes the keys along the front side of the instrument; shifting, wiggle, and other movement will not be tolerated.

In the present state of the art, X-stands (which are commercially available in both single- and double-braced forms) are of welded construction. Thus, the four support members, or crosspieces (i.e., two arms at the top and two feet at the bottom), are welded to the opposite ends of the legs, albeit the two individual legs of a single-brace assembly, and the four-paired legs of a double-brace assembly, are pivotably interconnected at a central hinge location. While providing a very strong and stable structure, there are a number of disadvantages associated with such a welded construction. In particular, manufacture, transport and storage are relatively expensive, the latter costs being increased substantially due to the limited collapsibility of the welded stands described.

### SUMMARY OF THE INVENTION

Accordingly, it is the broad object of the present invention to provide an X-style stand wherein the top and bottom support members are readily removed from the X-brace assembly, which stand nevertheless provides a high level of strength and stability.

It is a related object of the invention to provide a stand having the foregoing features and advantages, packaged in a container that is of very substantially reduced volume, as compared to that which is required for a welded stand of corresponding set-up dimensions.

It has now been found that certain of the foregoing and related objects of the invention are attained by the provision of a stand consisting of an X-brace assembly in combination with four removable crosspiece members, wherein weldments and fasteners are so employed as to substantially preclude wiggle, shifting, or other undesirable movement at the points of crosspiece connection, in normal use of the stand. More particularly, the stand comprises an X-brace assembly and at least four elongate crosspiece members disengageably assembled therewith in a generally perpendicular relationship thereto. At least two of the crosspiece members constitute upper support members and at least two of the crosspiece members constitute lower support members. The X-brace assembly comprises at least first and second legs, each leg having an upper end portion and an opposite lower end portion and the legs being pivotably attached to one another at a hinge point intermediate the opposite end portions thereof.

Each support member has a joining piece attached thereon intermediate the ends thereof. The joining piece is comprised of axially opposing end portions and transversely opposing side portions; it is dimensioned and configured to telescopically interengage (externally or internally) one of the opposite end portions of an associated one of the X-brace assembly legs in a close-fit relationship; it is secured to the support member to which it is attached by weldments extending along its opposing side portions, generally parallel to the longitudinal axis of the associated support member; and it has at least one aperture providing a passage extending from end-to-end therethrough, parallel to the longitudinal axis of the associated support member. Each of the upper and lower end leg portions has at least one aperture providing a passage extending therethrough and aligned with the passage through the joining piece with which the end portion of the associated leg is interengaged. The stand additionally includes an elongate, removable fastener extending through the aligned passages in each of the joining pieces and associated leg end portions, whereby the support members are securely and disengageably affixed on the first and second legs of the X-brace assembly.

In preferred embodiments of the stand, each of the joining pieces will comprise a sleeve piece in which the end portion of the associated brace assembly leg is received. The opposing end portions and the opposing side portions of the sleeve piece will comprise end walls and side walls, respectively, and the passage through the sleeve piece will be provided by aligned apertures in the end walls. In such an embodiment, each of the fasteners will desirably comprise a nut and bolt, the tightening of which will cause the end walls of the sleeve piece to be compressed into intimate contact with the end portion of the leg. Utilization of such an external, receiving sleeve piece (rather than, for example, a solid, internally received block) is especially desirable in those instances in which the X-brace assembly further comprises a height-adjusting positioning mechanism that includes an operating handle, which is advantageously mounted to slide in a slot formed through one of the end walls of the sleeve piece.

In most instances, the joining pieces and the end portions of the X-brace assembly legs will be of rectangular (e.g., square) cross section, with the legs being of correspondingly shaped tubular metal construction. The crosspiece members will usually be mutually parallel, and the stand will usually include a protective cap engaged over both ends of each support member.

In certain embodiments of the invention, the X-brace assembly will additionally comprise third and fourth legs disposed parallel, respectively, to the first and second legs and pivotably attached to one another in such manner that the hinge points of the two pairs of legs are coaxial. Each of the support members employed in combination with such an X-brace assembly will additionally include a second joining piece, attached thereon and interengaged with one of the opposite end portions of the third and fourth legs, with a fastener extending through the aligned passages, as described.

Other objects of the invention are attained by the provision of a packaging combination comprised of a carton and a collapsed X-style stand contained therein, the stand being constructed as described and having the features herein set forth. The collapsed stand is arranged with the legs of the X-brace assembly substantially mutually parallel, and with all of the crosspiece members removed from, and disposed substantially parallel to, the legs of the X-brace assembly and in mutually close-fit relation thereto and to one another. The space within the carton is substantially limited to that which is necessary to accommodate the collapsed stand.

### BRIEF DESCRIPTION OF THE DRAWINGS

FIG. 1 is a perspective view of a single-braced X-stand embodying the present invention;

FIG. 2 is a perspective view of a double-braced version of the stand;

FIG. 3 is an exploded, fragmentary perspective view showing the upper end portion of one of the legs of the brace assembly of the stand of FIG. 1 and the support arm to be attached thereto, from which the end caps have been removed;

FIG. 4 is a view similar to FIG. 3, taken from the opposite side;

FIG. 5 is a view similar to FIGS. 3 and 4, showing the parts fastened in assembly;

FIG. 6 is a fragmentary elevational view, in partial section, depicting the same subassembly;

FIG. 7 is a view similar to FIG. 5, showing the support arm and upper leg portions of the double-braced stand of FIG. 2, the end caps being removed from the support members;

FIG. 8 is a fragmentary side elevational view of the subassembly of FIG. 7;

FIG. 9 consists of (A) a side view, (B) an end view, and (C) a perspective view of a packaged X-style stand of welded construction, representative of the prior art; and

FIG. 10 consists of corresponding views showing a packaged X-style stand, of the same set-up size, embodying the present invention.

### DETAILED DESCRIPTION OF THE PREFERRED AND ILLUSTRATED EMBODIMENTS

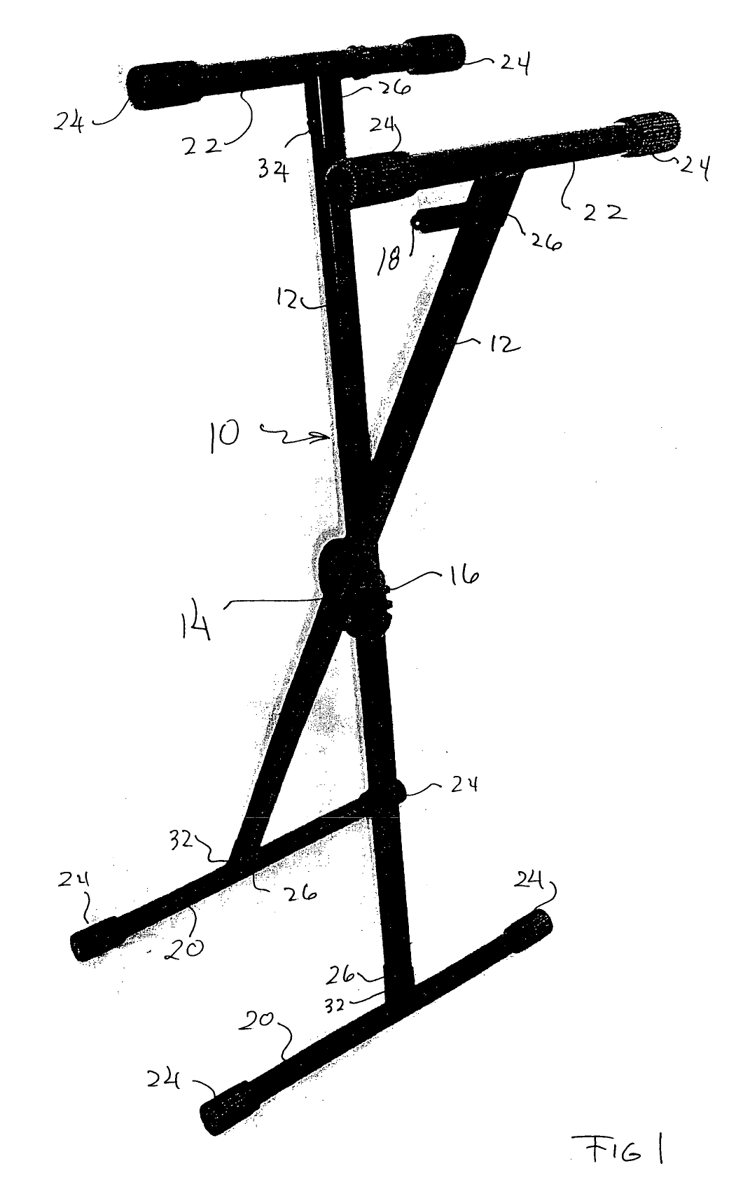

Turning initially to FIG. 1 of the drawings, therein illustration is an X-style keyboard stand embodying the present invention and comprising an X-brace assembly, generally designated by the numeral 10. The brace assembly consists of two legs 12, fabricated from square tubing and pivotably interconnected, at a central hinge point, by a transversely extending fastener 14. As is conventional, the brace assembly includes a positioning disk 16 having a series of circumferential notches for engaging a locking pin (not seen), operated by a handle 18 connected thereto by linkages (also not shown). This mechanism (and similar arrangements using apertured discs, notched locking bars, etc.) enables ready adjustment of the height of the stand.

A floor-engaging foot, or lower crosspiece support 20, is attached at the bottom of each of the legs 12 and extends with its longitudinal axis perpendicular thereto. Similarly, an instrument-rest arm, or upper crosspiece support 22, is attached at the top of each leg 12 and also extends with its longitudinal axis parallel thereto. A protective cap 24 (normally made of an elastomeric material) is engaged over the ends of each crosspiece 20, 22, providing eight contact points for the stand (i.e., with the floor and under the supported instrument).

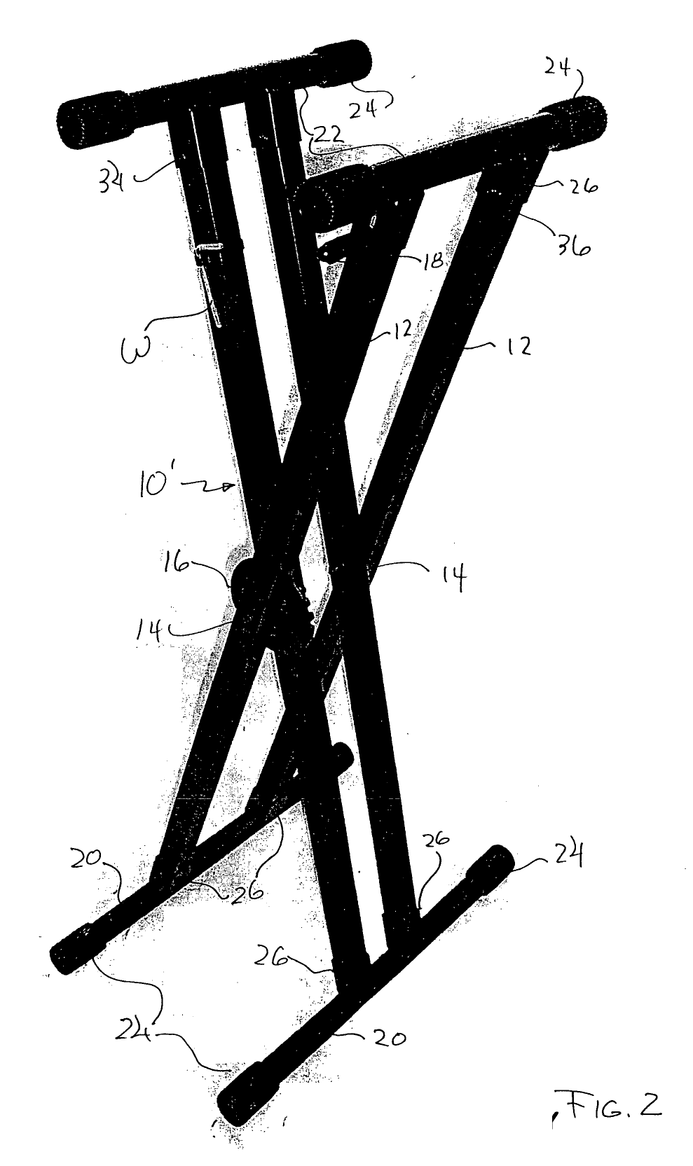

The double-braced stand shown in FIG. 2 and generally designated by the numeral 10′ is of the same construction as that of FIG. 1 (and hence the same numbers are used to designate corresponding elements), the primary exception being that four legs 12 are employed, with a parallel pair thereof being associated with each set of upper and lower crosspieces 20, 22. Each leg of a parallel pair is pivotably connected to a corresponding leg of the other pair by a fastener 14, but with only one positioning disk and operatively connected handle 18 being provided. As can be seen, each foot support 20 and arm support 22 is attached at two locations to the bottom and top portions of the legs 12, as the case may be. FIG. 2 also shows an Allen wrench W clipped to the side of one of the legs 12 for ready access; the wrench fits the screws that are used to secure the support members on the brace assembly, as will be described below.

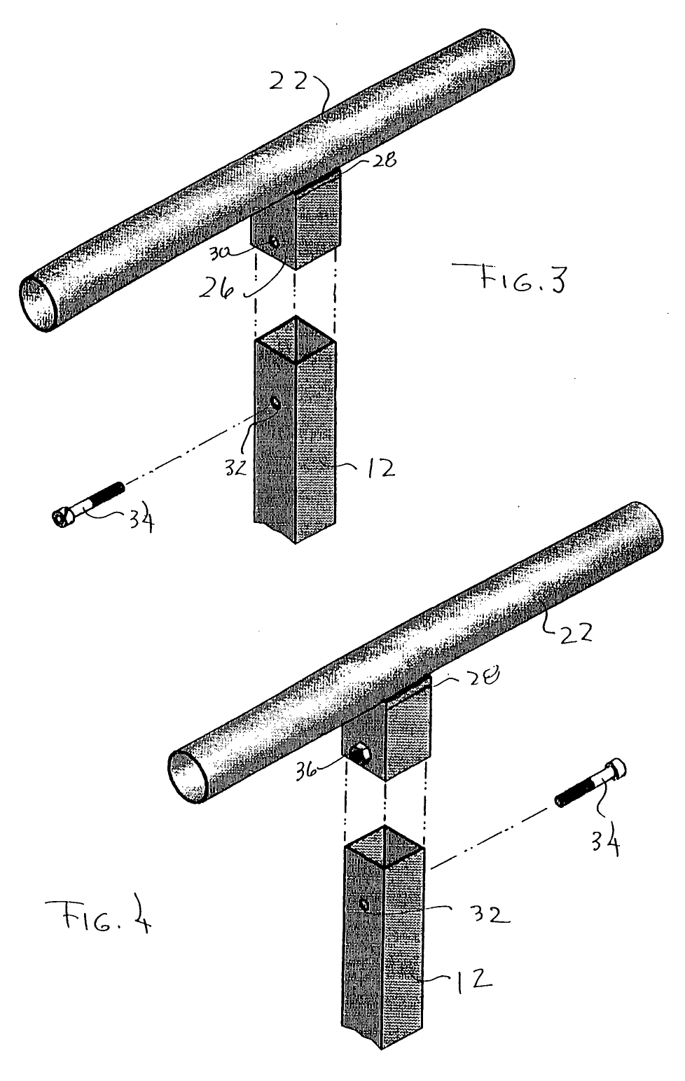

Turning additionally now to FIGS. 3-6 of the drawings, the means by which the crosspieces are removably attached to the brace assembly legs is described in greater detail. It will be appreciated that, although only one supporting arm 22 and the corresponding upper portion of one leg is illustrated, the second arm 22, as well as both feet 20, is joined to the associated leg in the manner hereinafter described.

As can be seen, a short length of square metal tubing 26, or sleeve piece, is welded to the arm 22 at an intermediate location (somewhat offset from the center), with the weldment 28, formed at the top edge of the sleeve piece 26 along each side, extending parallel to the longitudinal axis of the arm. A pair of apertures 30 are formed through opposing end walls of the sleeve piece 26 and are also aligned on an axis parallel to that of the arm 22, and a corresponding pair of aligned apertures 32 are formed through opposite walls of the leg 12. It will be appreciated that the inside dimensions of the sleeve piece 26 are slightly larger than the outside dimensions of the leg 12, such that the sleeve piece can be engaged telescopically over the end portion of the leg 12 in a close, sliding-fit relationship.

In assembly, all of the apertures 30, 32 lie in alignment, enabling the bolt 34 (a socket head cap screw) to pass through them, parallel to the axis of the arm 22, for threaded engagement with the nut 36 which is fastened (e.g., welded) to the outside surface of one of the walls of the sleeve piece 26 surrounding the aperture 30 therein. When tightened, the bolt 34 compresses the opposite end walls of the sleeve piece slightly, taking up any gap and forming a very strong and tight joint. It will be appreciated that the parallel relationship of the weldment 28 and the bolt 34, relative to the longitudinal axis of the arm 22, contributes substantially to the strength and stability of the connection and hence to the overall strength and stability of the assembled stand.

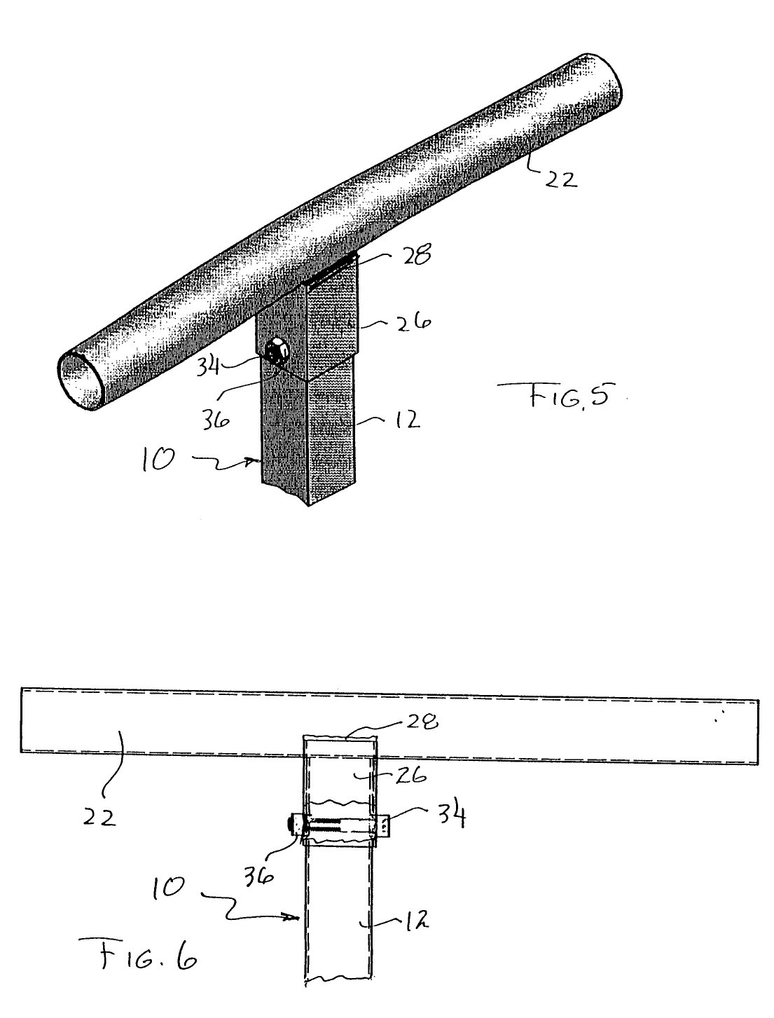

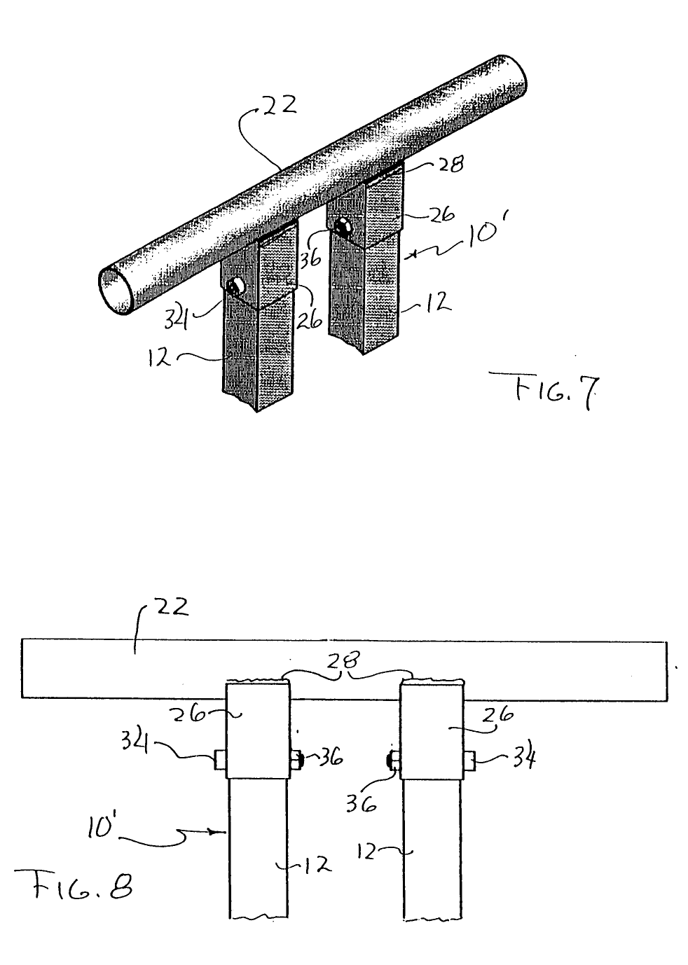

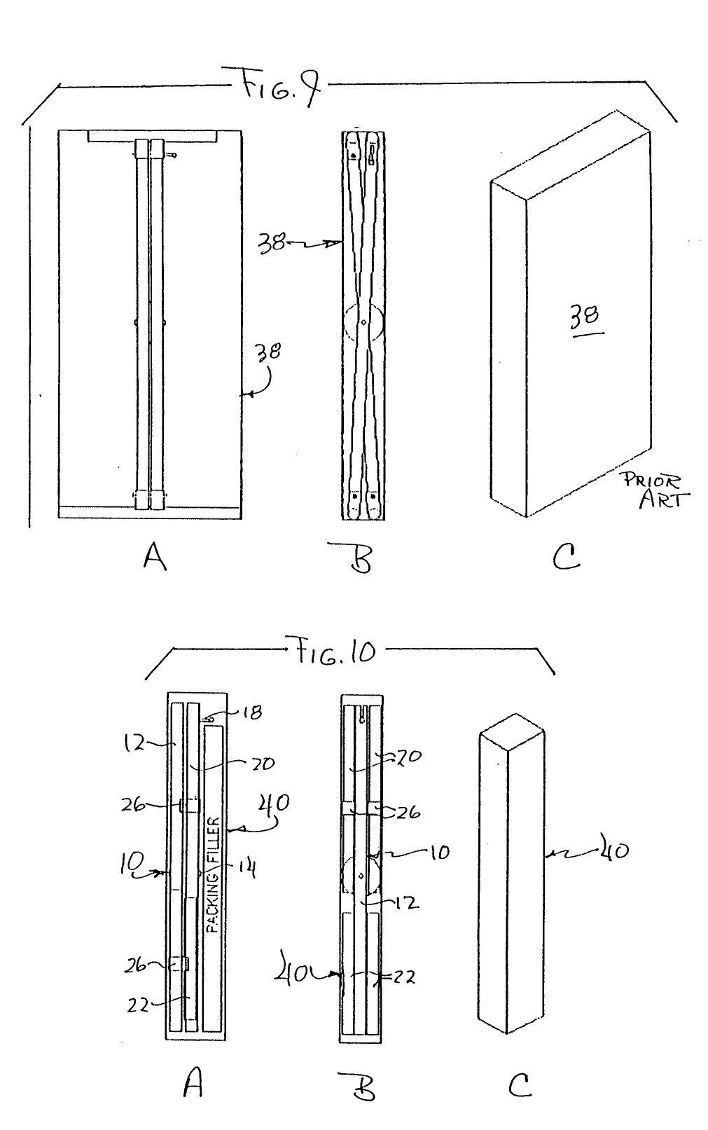

FIGS. 8 and 9 show a corresponding subassembly for the double-braced stand of FIG. 2. Apart from the provision of two sleeve pieces 24 on the arm 22, arranged in suitably adjusted positions, the features shown in these figures correspond to those FIGS. 5 and 6 and consequently bear the same numbers.

Turning finally to FIGS. 9 and 10 of the drawings, depicted therein are, respectively, a prior art single-braced X-stand, of welded construction, and an equivalent single-braced X-stand embodying the present invention, each contained in a carton, shown diagrammatically and generally designated by the numerals 38 and 40 (in FIG. 10B the packing filler is removed). As can perhaps best be seen in parts C of the figures, the ability to disassemble the crosspieces from the X-brace, in accordance with the present invention, permits the entire stand to fit within a space that is less than half the volume required by the conventional welded X-stand, as represented by the carton 38 for the prior art stand, and by the carton 40 for the stand of the invention. It should perhaps be pointed out that the legs of the X-brace assembly are typically at least about 36 inches long, the upper support members are typically at least about 12 inches long, and the lower support members are typically at least about 16 inches long; the legs and joining pieces will desirably interengage telescopically through a length of at least about two inches.

In view of the asymmetric character of the stands (i.e., the crosspieces are not generally centered, from front-to-back, on the legs) the opportunity exists for assembly in incorrect relationships. A coding system may therefore be incorporated to afford a quick and reliable means for correct assembly, in accordance with which an identifying color, number, letter, or the like may be provided at a suitable location on or adjacent each sleeve piece, with the same color, number, or letter being provided at a suitable location on the leg that is to be inserted into that particular piece.

Thus, it can be seen that the present invention provides an X-style stand, generally of tubular metal construction, in which the top and bottom support members are readily removed from the X-brace assembly, which stand nevertheless provides a high level of strength and stability. The invention also provides a stand, having the foregoing features and advantages, packaged in a container that is of very substantially reduced volume as compared to that which is required for a welded stand of corresponding set-up dimensions.

1. An X-style stand comprising an X-brace assembly and at least four elongate crosspiece members disengageably assembled therewith in a generally perpendicular relationship thereto, at least two of said crosspiece members constituting upper support members and at least two of said crosspiece members constituting lower support members; said X-brace assembly comprising at least first and second legs, each of said legs having an upper end portion and an opposite lower end portion, and said legs being pivotably attached to one another at a hinge point intermediate said opposite end portions thereof; each of said support members having a joining piece attached thereon intermediate the ends thereof, said joining piece being comprised of axially opposing end portions and transversely opposing side portions, said joining piece being dimensioned and configured to telescopically interengage one of said opposite end portions of an associated one of said X-brace assembly legs in a close-fit relationship, said joining piece being secured to said support member to which it is attached by weldments extending along said opposing side portions generally parallel to the longitudinal axis of said associated support member, and said joining piece having at least one aperture providing a passage extending from end-to-end therethrough, parallel to said longitudinal axis of said associated support member; each of said upper and lower end portions of said legs having at least one aperture providing a passage extending therethrough and aligned with said passage through said joining piece with which said end portion of said associated leg is interengaged; said stand additionally including an elongate, removable fastener extending through said aligned passages in each of said joining pieces and said end portion of said leg associated therewith, whereby said support members are securely and disengageably affixed on said first and second legs of said X-brace assembly.

2. The stand of claim 1 wherein each of said joining pieces comprises a sleeve piece in which said end portion of said associated brace assembly leg is received; wherein said opposing end portions and said opposing side portions of each of said sleeve pieces comprise end walls and side walls, respectively; and wherein said passage through said each sleeve piece is provided by aligned apertures in said end walls.

3. The stand of claim 1 wherein said joining pieces, and said end portions of said X-brace assembly legs, are of rectangular cross section.

4. The stand of claim 3 wherein said legs of said X-brace assembly are of tubular metal construction.

5. The stand of claim 1 wherein said each of said fasteners comprises a nut and bolt.

6. The stand of claim 2 wherein said each of said fasteners comprises a nut and bolt, and wherein said end walls of said sleeve pieces are compressed by said fasteners into intimate contact with said end portions of said legs.

7. The stand of claim 1 wherein said crosspiece members are mutually parallel.

8. The stand of claim 2 wherein said X-brace assembly further comprises a height-adjusting positioning mechanism that includes an operating handle slidably mounted in a slot formed through one of said end walls of said sleeve piece attached to one of said upper support members.

9. The stand of claim 1 additionally including a protective cap engaged over each of said ends of said support members.

10. The stand of claim 1 wherein said X-brace assembly additionally comprises third and fourth said legs disposed parallel, respectively, to said first and second legs and pivotably attached to one another at a hinge point axially aligned with said first-mentioned hinge point; wherein each of said support members additionally includes a second said joining piece so attached thereon and interengaged with one of said opposite end portions of said third and fourth legs; and wherein said stand additionally includes a said fastener extending through said aligned passages in said second joining pieces and said end portions of said third and fourth legs associated therewith, to so affix said second joining pieces and associated legs to one another.

11. An X-style stand package consisting essentially of a carton and a collapsed X-style stand contained therein; said X-style stand comprising an X-15 brace assembly and at least four elongate crosspiece members constructed for disengageable assembly with said X-brace assembly in a generally perpendicular relationship thereto, at least two of said crosspiece members constituting upper support members and at least two of said crosspiece members constituting lower support members; said X-brace assembly comprising at least first and second legs, each of said legs having an upper end portion and an opposite lower end portion, and said legs being pivotably attached to one another at a hinge point intermediate said opposite end portions thereof; each of said upper support members having a joining piece attached thereon intermediate the ends thereof, said joining piece being comprised of axially opposing end portions and transversely opposing side portions, said joining piece being dimensioned and configured to telescopically interengage one of said opposite end portions of an associated one of said X-brace assembly legs in a close-fit relationship, said joining piece being secured to said support member to which it is attached by weldments extending along said opposing side portions generally parallel to the longitudinal axis of said associated support member, and said joining piece having at least one aperture providing a passage extending from end-to-end therethrough, parallel to said longitudinal axis of said associated support member; each of said upper and lower end portions of said legs having at least one aperture providing a passage extending therethrough and positioned to align with said passage through said joining piece with which end portion of said associated leg is interengable; said collapsed stand being arranged with said legs of said X-brace assembly substantially mutually parallel and with all of said crosspiece members removed from said X-brace assembly and arranged substantially parallel to said legs thereof and in mutually close-fit relation to one another and to said X-brace assembly, the space within said carton being substantially limited to that which is necessary to accommodate said collapsed stand.

12. The package of claim 11 wherein said stand additionally includes elongate, removable fasteners constructed to extend through said passages in said joining pieces and said end portions of said legs associated therewith to securely and disengageably affixed said support members on said first and second legs of said X-brace assembly
